(19) United States
(12) Patent Application Publication
(10) Pub. No.: US 2006/0250547 A1
(43) Pub. Date: Nov. 9, 2006

(54) Optically compensated birefringence (OCB) mode liquid crystal display device

(75) Inventors: Jeong Dong Noh, Kyoungki-do (KR); Dong Hae Suh, Seoul (KR); Jae Chang Kim, Busan (KR); Tae Hoon Yoon, Busan (KR); Chul Gyu Jhun, Busan (KR)

Correspondence Address: SEYFARTH SHAW LLP, 131 S. DEARBORN ST., SUITE2400, CHICAGO, IL, 60603-5803, US

(73) Assignee: Boe Hydis Technology Co., Ltd.

(21) Appl. No.: 11/332,278

(22) Filed: Jan. 13, 2006

(30) Foreign Application Priority Data
May 6, 2005 (KR) 10-2005-0037931

(51) Int. Cl. G02F 1/1335

(52) U.S. Cl. 349/97

(57) ABSTRACT

Disclosed is an OCB mode LCD device. The OCB mode LCD device includes a liquid crystal cell interposed between substrates, which are rubbed in a predetermined direction, an upper phase delay film aligned above the liquid crystal cell, an upper circular polarizing plate aligned below the upper phase delay film, a lower phase delay film aligned symmetrically to the upper phase delay film, and a lower circular polarizing plate aligned symmetrically to the upper circular polarizing plate and including an optical axis perpendicular to that of the upper circular polarizing plate. The optical axis direction of the polarizing plate is the same as the rubbing direction of the liquid crystal cell, thereby compensating for the phase delay caused by the liquid crystal molecules having the bend structure and realizing the completely dark state while ensuring wide viewing angle characteristics.

### BACKGROUND OF THE INVENTION

1. Field of the Invention

The present invention relates to a liquid crystal display (LCD) device. More particularly, the present invention relates to an OCB (optically compensated birefringence) mode LCD device having wide viewing angle characteristics with fast response speed and high-resolution functions.

2. Description of the Prior Art

As generally known in the art, an LCD device can be fabricated in a compact size with lightweight, low-voltage drive and low power consumption functions. Due to the above advantages, the LCD devices have been extensively developed instead of cathode ray tubes (CRTs). In particular, a thin film transistor (TFT) LCD device can provide a large-sized display screen while realizing superior image quality and excellent colorization similar to those of the CRT, so the TFT LCD device has been spotlighted in various information and technology fields.

Such an LCD device mainly includes an array substrate formed with a TFT and a pixel electrode, a color filter substrate formed with a color filter and a counter electrode, and a liquid crystal layer aligned between the array substrate and the color filter substrate. In general, a twisted nematic (TN) mode liquid crystal is mainly used for the LCD device.

However, although the TN mode LCD device has a high contrast ratio, it presents a low response speed and narrow viewing angle characteristics. For this reason, an OCB (optically compensated bend) mode LCD device having improved viewing angle characteristics with a fast response speed has been proposed.

FIG. 1 shows a structure of a conventional OCB mode LCD device.

Referring to FIG. 1, the conventional OCB mode LCD device includes an upper substrate 12a, a lower substrate 12b, a liquid crystal cell 10 interposed between the upper and lower substrates 12a and 12b, upper and lower polarizing plates 14a and 14b symmetrically aligned at upper and lower portions of the liquid crystal cell 10, and phase compensation films 13a and 13b interposed between the upper and lower polarizing plates 14a and 14b and the liquid crystal cell 10, respectively.

The liquid crystal cell 10 is rubbed in a predetermined direction and liquid crystal molecules 11 contained in the liquid crystal cell 10 are aligned according to the rubbing direction of the liquid crystal cell 10.

When a voltage is applied to the liquid crystal cell 10, the liquid crystal molecules 11 are realigned in a bend structure and light passes through the liquid crystal molecules 11.

The upper and lower polarizing plates 14a and 14b are linear polarizing plates, in which an optical axis of the upper polarizing plate 14a is aligned perpendicularly to an optical axis of the lower polarizing plate 14b.

In addition, as shown in FIG. 2, the optical axes (a and b) of the upper and lower polarizing plates 14a and 14b are inclined from the rubbing direction (c) by an angle of 45°, respectively.

The phase compensation films 13a and 13b are provided to compensate for the phase delay created in the LCD device. That is, the phase compensation films 13a and 13b may compensate for the phase delay caused by the liquid crystal molecules 11, which are not perpendicularly aligned in the vicinity of the upper and lower substrates 12a and 12b, when realigning the liquid crystal molecules 11 in the form of the bend structure by applying the voltage to the liquid crystal cell 10. In other words, if the polarizing state varies due to the liquid crystal molecules 11, which are not perpendicularly aligned, a completely dark state cannot be obtained at a front of the LCD device. In this case, the phase compensation films 13a and 13b compensate for the phase delay caused by the liquid crystal molecules 11, which are not perpendicularly aligned.

According to the conventional OCB mode LCD device having the above structure, the liquid crystal molecules 11 are aligned in the form of the bend structure by applying the voltage to the liquid crystal cell 10 such that the light may pass through the liquid crystal molecules 11, and the phase delay caused by the liquid crystal molecules 11, which are not perpendicularly aligned in the vicinity of the upper and lower substrates 12a and 12b, is compensated by means of the phase compensation films 13a and 13b, thereby obtaining the completely dark state.

Such a completely dark state can be achieved by completely compensating for the phase delay using the phase compensation films 13a and 13b. To this end, the phase compensation films 13a and 13b must be accurately designed such that they can completely compensate for the phase delay of the liquid crystal cell.

However, it is very difficult to accurately design the phase compensation films 13a and 13b, so that it is difficult to obtain the completely dark state.

### SUMMARY OF THE INVENTION

Accordingly, the present invention has been made to solve the above-mentioned problems occurring in the prior art, and an object of the present invention is to provide an OCB mode LCD device capable of realizing a completely dark state by simply compensating for a phase delay.

In order to accomplish the above object, according to the present invention, there is provided an OCB mode LCD device comprising: a liquid crystal cell interposed between a pair of substrates, which are spaced apart from each other and opposite surfaces thereof are rubbed; an upper phase delay film aligned at an upper portion of the liquid crystal cell; an upper circular polarizing plate aligned at an upper portion of the upper phase delay film; a lower phase delay film aligned at a lower portion of the liquid crystal cell symmetrically to the upper phase delay film; and a lower circular polarizing plate aligned at a lower portion of the lower phase delay film symmetrically to the upper circular polarizing plate and including an optical axis aligned perpendicularly to an optical axis of the upper circular polarizing plate.

According to the preferred embodiment of the present invention, the upper circular polarizing plate includes an upper linear polarizing plate and an upper λ/4 phase delay plate stacked on the upper linear polarizing plate while facing the liquid crystal cell and the lower circular polarizing plate includes a lower linear polarizing plate and a lower λ/4 phase delay plate stacked on the lower linear polarizing plate while facing the liquid crystal cell.

One of optical axes of the upper and lower linear polarizing plates is aligned in a same direction as a rubbing direction of the substrates.

One of optical axes of the upper and lower λ/4 phase delay plates is inclined with respect to a rubbing direction of the substrates by an angle of 45°.

Preferably, the upper and lower phase delay films have a phase delay range of about 20 to 100 nm in a front direction thereof and about 200 to 400 nm in a thickness direction thereof.

In addition, the upper and lower λ/4 phase delay plates have λ/4 phase delay values corresponding to a wavelength range of a visible ray.

According to the present invention, the upper and lower phase delay films include a front phase delay film and a inclined phase delay film, respectively.

Preferably, the upper and lower phase delay films can be substituted by a biaxial film, respectively.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view illustrating a conventional OCB mode LCD device;

FIG. 2 is a view illustrating optical axes of polarizing plates shown in FIG. 1 and a rubbing direction of a liquid crystal cell;

FIG. 3 is an exploded perspective view illustrating an OCB mode LCD device according to one embodiment of the present invention;

FIG. 4A is a graph illustrating a simulation result of transmittance as a function of a voltage when a front phase delay film is used or not;

FIG. 4B is a graph illustrating an actual measurement result of transmittance as a function of a voltage when a front phase delay film is used or not;

FIG. 5 is a view illustrating optical axes of linear polarizing plates shown in FIG. 3 and a rubbing direction of a liquid crystal cell;

FIG. 6A is a contour map illustrating simulation values representing viewing angle characteristics of the conventional OCB mode LCD device shown in FIG. 1;

FIG. 6B is a contour map illustrating simulation values representing viewing angle characteristics of the OCB mode LCD device shown in FIG. 3; and

FIG. 7 is a perspective view illustrating a phase delay film according to another embodiment of the present invention.

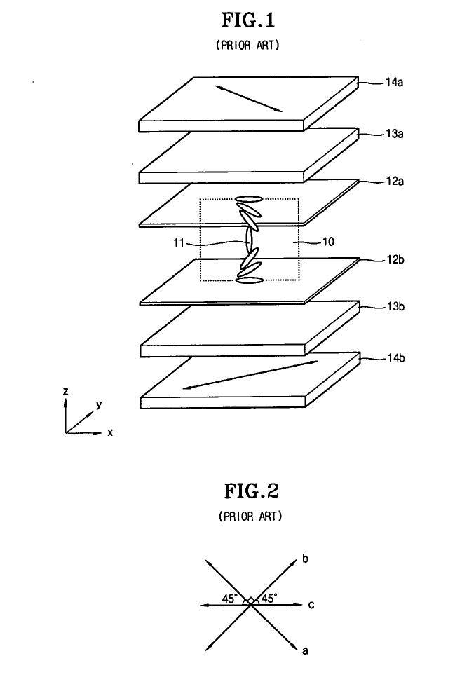

### DETAILED DESCRIPTION OF THE PREFERRED EMBODIMENTS

Hereinafter, the present invention will be described with reference to accompanying drawings.

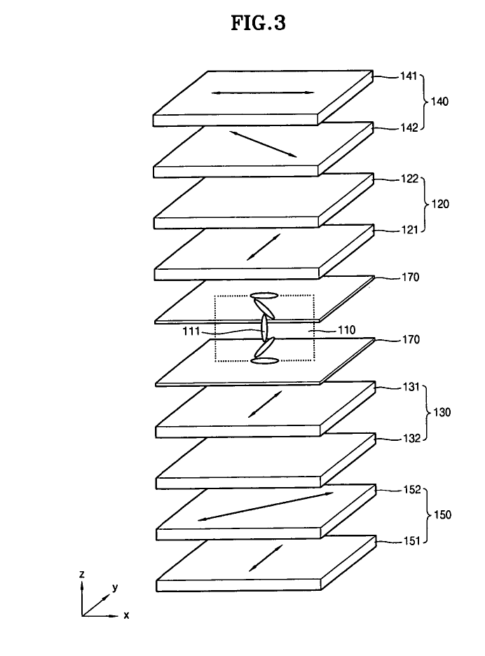

FIG. 3 is an exploded perspective view illustrating an OCB mode LCD device according to one embodiment of the present invention.

Referring to FIG. 3, the OCB mode LCD device of the present invention includes a liquid crystal cell 110, phase delay films 120 and 130 and circular polarizing plates 140 and 150.

The liquid crystal cell 110 consists of liquid crystal molecules 111 and is interposed between a pair of substrates 170 which are rubbed in a predetermined direction. The liquid crystal molecules 111 are aligned along the rubbing direction. Herein, the predetermined direction is defined as an X-axis direction.

The phase delay films 120 and 130 include an upper phase delay film 120 and a lower phase delay film 130. In addition, the upper and lower phase delay films 120 and 130 include upper and lower front phase delay films 121 and 131 and upper and lower inclined phase delay films 122 and 132, respectively.

The upper and lower phase delay films 120 and 130 are symmetrically aligned at upper and lower portions of the liquid crystal cell 110.

In addition, the upper and lower front phase delay films 121 and 131 are stacked on the upper and lower inclined phase delay films 122 and 132 while facing the liquid crystal cell 110, respectively.

The upper and lower front phase delay films 121 and 131 are provided to compensate for the phase delay at a front of the OCB mode LCD device, so they have optical axes perpendicular to the rubbing direction of the liquid crystal cell 110. In order to realize sufficient brightness, the upper and lower front phase delay films 121 and 131 have compensation values corresponding to delay values in an On-state of the OCB mode LCD device.

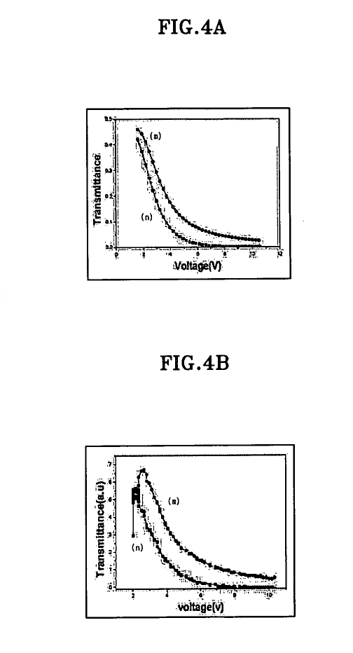

FIGS. 4A and 4B are graphs illustrating a simulation result and an actual measurement result of transmittance as a function of a voltage when the upper and lower front phase delay films 121 and 131 are used or not.

In FIGS. 4A and 4B, “(m)” represents the simulation result and the actual measurement result when the upper and lower front phase delay films 121 and 131 are not used, and “(n)” represents the simulation result and the actual measurement result when the upper and lower front phase delay films 121 and 131 are used.

Referring to FIGS. 4A and 4B, the simulation result and actual measurement result represent that the transmittance value obtained with the upper and lower front phase delay films 121 and 131 more closely converges into “0” than the transmittance value obtained without using the upper and lower front phase delay films 121 and 131. That is, it is possible to realize the completely dark state when using the upper and lower front phase delay films 121 and 131.

The circular polarizing plates 140 and 150 include an upper circular polarizing plate 140 and a lower circular polarizing plate 150. The upper circular polarizing plate 140 includes an upper λ/4 phase delay plate 142 and an upper linear polarizing plate 141 and the lower circular polarizing plate 150 includes a lower λ/4 phase delay plate 152 and a lower linear polarizing plate 151.

The upper and lower circular polarizing plates 140 and 150 are aligned at upper and lower portions of the upper and lower phase delay films 120 and 130, respectively.

In addition, the upper and lower λ/4 phase delay plates 142 and 152 are stacked on the upper and lower linear polarizing plates 141 and 151, respectively, while facing the liquid crystal cell 110.

Optical axes of the upper and lower linear polarizing plates 141 and 151 are aligned perpendicularly to each other. According to the present invention, the optical axis of the upper linear polarizing plate 141 extends in an X-axis direction and the optical axis of the lower linear polarizing plate 151 extends in a Y-axis direction. However, it is also possible to align the optical axes of the upper and lower linear polarizing plates 141 and 151 in the Y-axis and X-axis directions, respectively.

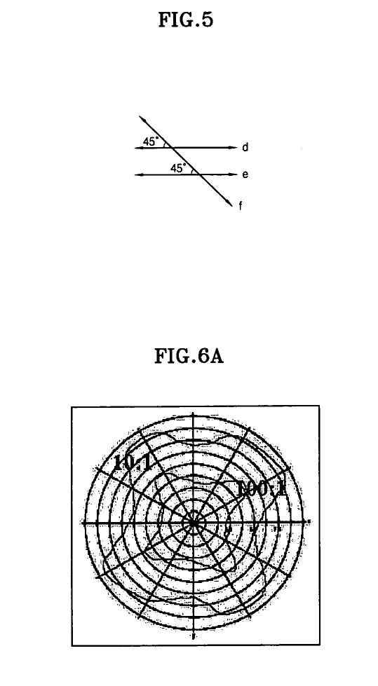

Herein, as shown in FIG. 5, one of the optical axes of the upper and lower linear polarizing plates 141 and 151, for example, an optical axis (e) is aligned in the same direction as the rubbing direction (d) of the liquid crystal cell 110.

According to the conventional OCB mode LCD device, a wide viewing angle can be obtained in the optical axis directions of the upper and lower linear polarizing plates. However, the viewing angle may be inclined between the optical axes of the upper and lower linear polarizing plates, so the upper linear polarizing plate may not maintain orthogonality with respect to the lower linear polarizing plate so that the alignment of the liquid crystal molecules are offset from the optical axis directions of the upper and lower linear polarizing plates.

Therefore, light leakage may occur so that the completely dark state cannot be obtained in the optical axis directions of the upper and lower linear polarizing plates.

According to the present invention, in order to prevent the light leakage, one of the optical axes of the upper and lower linear polarizing plates 141 and 151 (e.g., an optical axis (e)) is aligned in the same direction as the rubbing direction (d) of the liquid crystal cell 110. Thus, the liquid crystal molecules 111 are aligned corresponding to the optical axis direction even if the viewing angle is inclined, thereby realizing the completely dark state and maximizing the viewing angle.

Optical axes of the upper and lower λ/4 phase delay plates 142 and 152 are perpendicular to each other. At this time, the optical axes (f) of the upper and lower λ/4 phase delay plates 142 and 152 may form angles of 45° and −45° with respect to the rubbing direction (d) of the liquid crystal cell 110, respectively. The above angles are preferred for the on/off operation of the liquid crystal cell 111.

In addition, the phase delay films 120 and 130 have the phase delay range of about 20 to 100 nm in the front direction thereof and about 200 to 400 nm in the thickness direction thereof.

That is, the phase delay films 120 and 130 have the phase delay value of (nx−ny)×d=20˜100 nm in the front direction and the phase delay value of {(nx+ny)/2−nz}×d=200˜400 nm in the thickness direction, wherein n is a refractive index and d is a cell gap.

In addition, in order to minimize characteristic variation depending on the wavelength, the upper and lower λ/4 phase delay plates 142 and 152 have λ/4 phase delay values in a range of about 400 to 800 nm, which corresponds to a wavelength range of a visible ray.

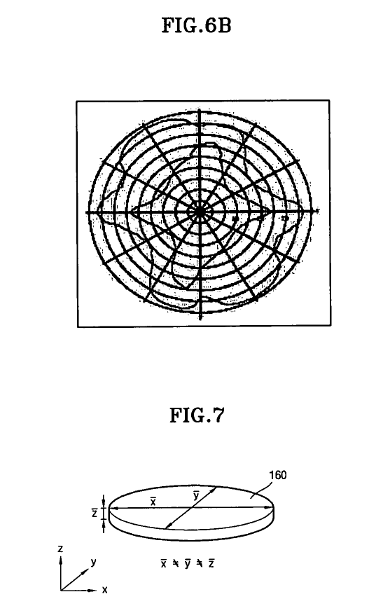

FIGS. 6A and 6B are contour maps illustrating simulation values representing viewing angle characteristics of the conventional OCB mode LCD device and the OCB mode LCD device according to the present invention, respectively, wherein Δn and Δε of liquid crystal are 0.159 and 10 and the phase delay values in the front direction and thickness direction are 31 nm and 350 nm, respectively.

As can be understood from FIGS. 6A and 6B, the viewing angle of the OCB mode LCD device according to the present invention is wider than that of the conventional OCB mode LCD device. This means that the viewing angle characteristic of the OCB mode LCD device according to the present invention is superior to that of the conventional OCB mode LCD device.

In addition, according to another embodiment of the present invention, as shown in FIG. 7, a biaxial film 160 can be used for the upper and lower phase delay films. That is, the upper and lower phase delay films 120 and 130 including the inclined phase delay films 122 and 132 and front phase delay films 121 and 131 can be replaced with the biaxial film 160.

According to the OCB mode LCD device having the above structure, one of the optical axes of the upper and lower linear polarizing plates is aligned in the same direction as the rubbing direction of the liquid crystal cell, and λ/4 phase delay plates are stacked on the upper and lower linear polarizing plates, respectively, thereby compensating for the phase delay incurred when the voltage is applied to the liquid crystal cell. Thus, the OCB mode LCD device may have improved optical viewing angle characteristics with a fast response speed.

As described above, according to the OCB mode LCD device of the present invention, the optical axis direction of the polarizing plate is aligned in the same direction as the rubbing direction of the liquid crystal cell, thereby easily compensating for the phase delay caused by the liquid crystal molecules having the bend structure. Thus, it is possible to realize the completely dark state while ensuring wide viewing angle characteristics.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An OCB mode LCD device comprising:
a liquid crystal cell interposed between a pair of substrates, which are spaced apart from each other and opposite surfaces thereof are rubbed;
an upper phase delay film aligned at an upper portion of the liquid crystal cell;
an upper circular polarizing plate aligned at an upper portion of the upper phase delay film;
a lower phase delay film aligned at a lower portion of the liquid crystal cell symmetrically to the upper phase delay film; and
a lower circular polarizing plate aligned at a lower portion of the lower phase delay film symmetrically to the upper circular polarizing plate and including an optical axis aligned perpendicularly to an optical axis of the upper circular polarizing plate.

2. The OCB mode LCD device as claimed in claim 1, wherein the upper circular polarizing plate includes an upper linear polarizing plate and an upper λ/4 phase delay plate stacked on the upper linear polarizing plate while facing the liquid crystal cell and the lower circular polarizing plate includes a lower linear polarizing plate and a lower λ/4 phase delay plate stacked on the lower linear polarizing plate while facing the liquid crystal cell.

3. The OCB mode LCD device as claimed in claim 2, wherein one of optical axes of the upper and lower linear polarizing plates is aligned in a same direction as a rubbing direction of the substrates.

4. The OCB mode LCD device as claimed in claim 2, wherein one of optical axes of the upper and lower λ/4 phase delay plates is inclined with respect to a rubbing direction of the substrates by an angle of 45°.

5. The OCB mode LCD device as claimed in claim 2, wherein the upper and lower phase delay films have a phase delay range of about 20 to 100 nm in a front direction thereof and about 200 to 400 nm in a thickness direction thereof.

6. The OCB mode LCD device as claimed in claim 2, wherein the upper and lower λ/4 phase delay plates have λ/4 phase delay values in a range of about 400 to 800 nm, which corresponds to a wavelength range of a visible ray.

7. The OCB mode LCD device as claimed in claim 1, wherein the upper and lower phase delay films include a front phase delay film and a inclined phase delay film, respectively.

8. The OCB mode LCD device as claimed in claim 1, wherein the upper and lower phase delay films can be substituted by a biaxial film, respectively.
